(19) United States
(12) Patent Application Publication
(10) Pub. No.: US 2021/0039408 A1
(43) Pub. Date: Feb. 11, 2021

(54) CARRIAGE DELAYS FOR AREA FILL REGIONS

(71) Applicant: Hewlett-Packard Development Company, L.P., Spring, TX (US)

(72) Inventors: Antonio Gracia Verdugo, Barcelona (ES); Andrei Alexandru Dafinoiu, Sant Cugat del Valles (ES); Li Qian, Sant Cugat del Valles (ES)

(21) Appl. No.: 16/963,931

(22) PCT Filed: Feb. 26, 2018
(86) PCT No.: PCT/US2018/019675

§ 371 Date: Jul. 22, 2020

(51) Int. Cl. B41J 19/14; B41J 2/21; B29C 64/223; B29C 64/386; B29C 64/147

(52) U.S. Cl. CPC B41J 19/147; B41J 2/2132; B33Y 50/02; B29C 64/386; B29C 64/147; B29C 64/223

(57) ABSTRACT

In an example a system includes a carriage with a print head receiving station, a color variation engine, and a delay engine. The color variation engine identifies a potential color variation condition corresponding to an area fill region. The delay engine applies a carriage delay strategy according to the identified potential color variation condition and the size of the area fill region.

### BACKGROUND

Images are processed for use with computing machines, such as a print apparatus. A print apparatus, for example, may use control data based on processed image data to reproduce a physical representation of an image by operating a print fluid ejection system according to the control data. Image processing may include color calibration. An image may be processed in a print apparatus pipeline or processed offline on separate compute device, such as a print server.

### BRIEF DESCRIPTION OF THE DRAWINGS

FIGS. 1 and 2 are block diagrams depicting example imaging systems.

FIG. 3 depicts an example print apparatus in which various imaging systems may be implemented.

FIG. 4 depicts example components used to implement example imaging systems.

FIGS. 5-7 are flow diagrams depicting example methods of operating a carriage of a printer.

### DETAILED DESCRIPTION

In the following description and figures, some example implementations of print apparatus, imaging systems, and/or methods of operating a carriage of a printer comprising are described. In examples described herein, a “print apparatus” may be a device to print content on a physical medium (e.g., paper, textiles, a layer of powder-based build material, etc.) with a print material (e.g., ink or toner). For example, the print apparatus may be a wide-format print apparatus that prints latex-based print fluid on a print medium, such as a print medium that is size A2 or larger. In some examples, the physical medium printed on may be a web roll or a pre-cut sheet. In the case of printing on a layer of powder-based build material, the print apparatus may utilize the deposition of print materials in a layer-wise additive manufacturing process. A print apparatus may utilize suitable print consumables, such as ink, toner, fluids or powders, or other raw materials for printing. In some examples, a print apparatus may be a three-dimensional (3D) print apparatus. An example of fluid print material is a water-based latex ink ejectable from a print head, such as a piezoelectric print head or a thermal inkjet print head. Other examples of print fluid may include dye-based color inks, pigment-based inks, solvents, gloss enhancers, fixer agents, and the like.

Certain examples described herein relate to color calibration of a print system. For example, color calibration may be used to adjust the color response of the print system to more accurately correspond to a desired color to be printed. Color calibration may be used to calibrate a color mapping process by which a first representation of a given color is mapped to a second representation of the same color. The concept of “color” can be represented in a large variety of ways, such as in relation to a power or intensity spectrum of electromagnetic radiation across a range of visible wavelengths or a color model is used to represent a color at a lower dimensionality. A “color” may be said to be a category that is used to denote similar visual perceptions where two colors are said to be similar if they produce a similar effect on a group of one or more people. These categories can then be modelled using a lower number of variables. In an example printing pipeline, individual inks may be calibrated separately so that printed colors are similar to or match desired colors.

A color model may define a color space, i.e., a multi-dimensional space with dimensions of the space representing variables within the color model and a point in the multi-dimensional space representing a color value. For example, in a red, green, blue (RGB) color space, an additive color model defines three variables representing different quantities of red, green and blue light. Another color space includes a cyan, magenta, yellow and black (CMYK) color space, in which four variables are used in a subtractive color model to represent different quantities of colorant or ink, e.g., for a print system and an image with a range of different colors can be printed by overprinting images for each of the colorants or inks. Yet other examples include: the International Commission on Illumination (CIE) 1931 XYZ color space, in which three variables (‘X’, ‘Y’ and ‘Z’ or tristimulus values) are used to model a color; the CIE 1978 (L*, a*, b*—CIELAB or ‘LAB’) color space, in which three variables represent lightness (‘t’) and opposing color dimensions (‘a’ and ‘b’); and the Yu′v′ color space, in which three variables represent the luminance (‘Y’) and two chrominance dimensions (u′ and v′). Other spaces include area coverage spaces, such as the Neugebauer Primary area coverage (NPac) space, where each NPac vector may define the probability distribution for one or more colorant or ink combinations for each pixel in a haftone (e.g., a likelihood that a particular colorant or ink combination is to be placed at each pixel location in the halftone).

In thermal inkjet printing, nozzles are fired using pulses of energy through resistors. Heat accumulated during the firing process may change the properties of the liquid inside the print head. During runs using media greater than a A2 length, for example, the print head surface temperature may change as much as ten degrees Celsius from swath to swath (i.e., each pass of the print head over the media) and may generally change over the time of the print job. Such print head temperature changes may affect drop characteristics, such as drop weight and drop velocity. Color variation may result due to different drop characteristics changes and may yield customer dissatisfaction, especially when working with tiles with a consistent desired color if the result is different color variations among tiles.

Various examples described below relate to color adjustment for printing based on area fill characteristics of a print job using variable carriage delay. For example, color variation may occur in long print jobs and, by analyzing the image data for area fills that may produce color variation, print operations may be adjusted to inhibit variation in output color, including operations such as carriage movement. An area fill, as used herein, is an area greater than a threshold number of pixels that contains the same coloring and/or pattern. For example, an area may be an area fill region of size M×N when the region is larger than a 2 pixel threshold in the x or y direction (e.g., media width and media advance directions) and the pixels of the region are all designated to be the same color combination. An area fill region may be any shape including rectangular, square, triangular, circular, etc., or any free from shape that achieves the size thresholds. The continuous pixels of the area may have an image quality effect with respect to the entirety of the area. The color adjustment of an area of an image may involve identifying whether an area fill region exists, whether the color of the area is sensitive to carriage delay, and a change in delay between passes of the print carriage (i.e. interswath delay) to compensate for a potential color variation. By implementing a variable interswath delay based on the delay-sensitivity of a color, an area fill of that color may be uniform over the entire area fill (e.g., without color variation due to lengthy print jobs of the same color).

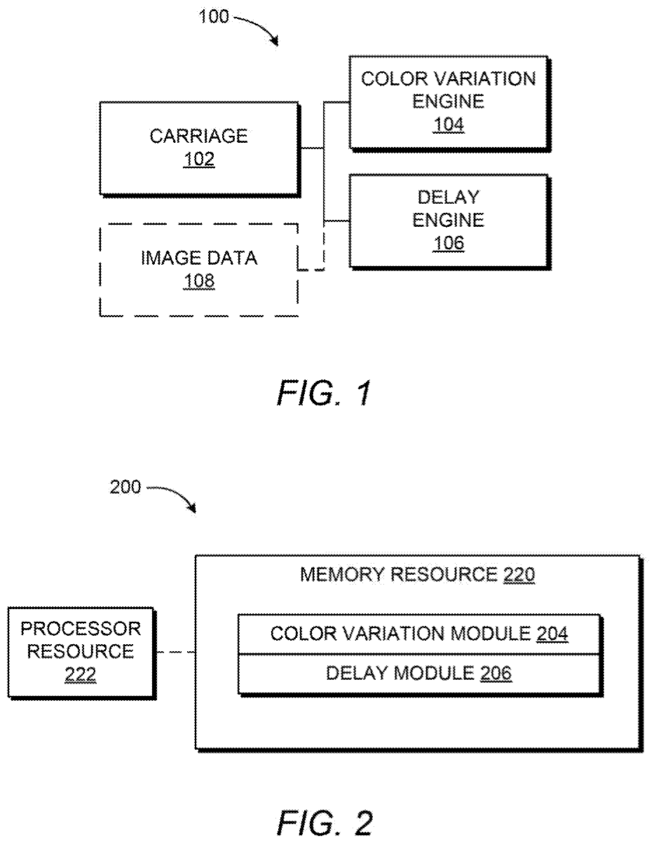

FIGS. 1 and 2 are block diagrams depicting example imaging systems. Referring to FIG. 1, the example imaging system 100 of FIG. 1 generally includes a carriage 102, a color variation engine 104, and a delay engine 106. In general, the color variation engine 104 may analyze the image data 108 for potential color variation conditions and the delay engine 106 may identify a delay to apply to movement of the carriage 102 during printing of the region corresponding to the potential color variation condition.

The carriage 102 represents mechanical structure to move along a path. For example, a printer carriage may include a print head receiving station for retaining a print head for ejecting print fluid on a print medium, where the print carriage is supported by a carriage beam across the width of a printer that allows the carriage to move along a scan axis over the width of the print medium.

The color variation engine 104 represents any circuitry or combination of circuitry and executable instructions to identify a potential color variation condition corresponding to an area fill region of image data 108 of a print job. For example, the color variation engine 104 may be a combination of circuitry and executable instructions to determine an area fill region of a print job is greater than a threshold size and determine whether the region is to be filled with a delay-sensitive color combination. A potential color variation condition represents a plurality of printing parameters corresponding to the image data of a print job that may generate a variation in color across a region that is intended to be the same color. For example, a print job larger than the print medium may be printed on and cut into tiles and then attached together, where a color in a first tile may look different from the same color in the second tile due to some variation of firing characteristics.

The color variation engine 104 identifies the potential color variation for a region of the image data 108 based on the size of the area fill region and the color of the area fill region. A color as discussed further herein is referred to as a color combination of colorant print fluid, which may include a combination of colorants within a color space of a printer to produce a particular color as well as the use of a single colorant to produce the color (e.g., use of cyan color ink to produce a cyan colored area fill region). Various color combinations may have differing sensitivity and limitations of area sizes before a color variation may occur. For example, a dark purple may not be sensitive to color variation from longer runs, while a light turquoise may be sensitive to color variation of runs of similar length. For another example, a green region may start to vary in hue after 30 swaths of the length of the print medium while an orange region may have variation after 20 swaths of the length of the print medium. Some color variations may be compensated for by increasing the interswath delay while printing the area fill, which may, as an example, give the print fluid more consistent firing properties. The colors may correspond to use with a print head, for example, the variation threshold may be based on the number of consecutive nozzle firings for a particular type of print head. For example, if any of the print heads with cyan, magenta, or yellow surpasses more than a certain number of consecutive nozzle firings in a swath, a color shift may occur over time based on changes to the surface of the print head, such as changes in temperature or amounts of print fluid sticking to the print head. Colors may be correlated for the purposes of delay determination based on print head configuration. For example, if cyan and black are fired out of a first print head and magenta and yellow are fired out of a second print head, the thresholds may be correlated to a combination of the colors corresponding to each print head.

The color variation engine 104 may determine which swaths correspond to an area fill region of image data of a particular color combination and determine the area fill region is prone to color variation, such as by comparing a number of swaths of the print job for the region to a variation threshold corresponding to the color combination. The color variation engine 104 may perform a densitometer analysis to identify primary color values to be used to print a region, where the combination of primary color values represents a color combination of the region. An area fill region may be identified when the primary color values are consistent for a threshold amount of firings corresponding to the region. The variation threshold may be predetermined or may be calculated from predetermined values. For example, the color variation engine 104 may use a data resource, such as a lookup table, that associates a color combination with a number of swaths corresponding to the variation threshold (e.g., the maximum number of swaths before a color variation is likely with that color). The color variation engine 104 may retrieve a color variation prone threshold amount from a lookup table that includes an array of sensitive colors and interswath delays corresponding to each of the sensitive colors, where the interswath delay may be used by the delay engine 106 to apply a change to movement of the carriage of the printer.

The color variation engine 104 may track the output of the swaths printing a color combination for more than a threshold number of swaths. For example, the color variation engine 104 may include a combination of circuitry and executable instructions to perform a densitometer analysis to observe a number of swaths that are to print a particular color combination, which may occur before the print job begins or before a set of swaths is performed. For another example, the color variation engine 104 may include a combination of circuitry and executable instructions to monitor color variations during printing, such as using active color sensors near the print zone to identify a difference between output of a previous swath and output of a subsequent swath. The size of the area fill region may be identified by a width of the area fill region (with respect to, for example, the scan axis of the carriage holding a print head to print the area fill region) and the length of the area fill region (with respect to, for example, the media advance direction, such as a number of swaths along the media advance direction where a swath may be the length a trench of nozzles of the print head to be coupled to the carriage of the printer).

The delay engine 106 represents any circuitry or combination of circuitry and executable instructions to apply a carriage delay strategy according to a potential color variation condition (e.g., the potential color variation condition identified by the color variation engine 104) and the size of the area fill region. For example, the delay engine 106 may be a combination of circuitry and executable instructions to identify an amount of time to delay between swaths based on the color and size of the area fill region identified by the color variation engine 104 and instruct the print carriage to perform the printing operations with the amount of time delayed in between a first and second pass corresponding to the region. The delay engine 106 may use predetermined information and/or calculations to identify the delay to apply to movement of the carriage when printing an area fill region of a particular size and a particular color. For example, the delay engine 104 may calculate an interswath delay based on the number of swaths of the print job for the area fill region and the number of swaths exceeding a variation threshold corresponding to the color combination, where the variation threshold may be a predetermined number of swaths corresponding to the color combination.

The carriage delay strategy represents any timing adjustments applied to carriage movement, whether uniform or variable. For example, the carriage delay strategy may be an outline of swaths categorized to include particular amounts of interswath delays, which may be delays in addition to mechanical delays under average operation or may be total delays desired between swaths. The amount of time to delay as discussed herein may be a variable amount of time less than one second and greater than zero.

The delay engine 106 uses the color information and the size information of the area fill to identify the amount of time to delay the carriage between swaths. The delay engine 106 may use other characteristics of the print job or status of the printer. For example, the delay engine 106 may determine an interswath delay based on a size of a number of tiles of the print job and a job length of the print job and determine an adjustment of the interswath delay based on the location of the area fill region compared to the size of the number of tiles. In that example, the delay may not be used for area fills that are near the same side of the spittoon of the printer, for example. As another example, the location of the area fill on the media may be used to make further adjustments or remove delay of the carriage where the travel time to the area fill region may be counted as part of the delay, such as travel time to the center of the media for an area fill at the center of the media.

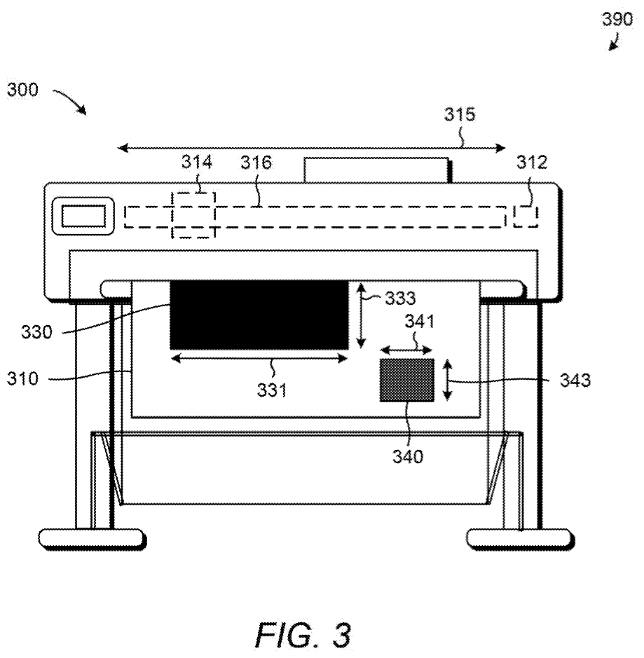

In some examples, functionalities described herein in relation to any of FIGS. 1-2 may be provided in combination with functionalities described herein in relation to any of FIGS. 3-7.

FIG. 2 depicts the example system 200 may comprise a memory resource 220 operatively coupled to a processor resource 222. Referring to FIG. 2, the memory resource 220 may contain a set of instructions that are executable by the processor resource 222. The set of instructions are operable to cause the processor resource 222 to perform operations of the system 200 when the set of instructions are executed by the processor resource 222. The set of instructions stored on the memory resource 220 may be represented as a color variation module 204 and a delay module 206. The color variation module 204 and the delay module 206 represent program instructions that when executed function as the color variation engine 104 and the delay engine 106 of FIG. 1, respectively. The processor resource 222 may carry out a set of instructions to execute the modules 204, 208, and/or any other appropriate operations among and/or associated with the modules of the system 200.

For example, the processor resource 222 may carry out a set of instructions to determine a trigger value corresponding to conditions that identify image data includes an area fill region of a threshold width and a color for the area fill region is prone to show color variation beyond a threshold amount, track a parameter of the image data corresponding to the area fill region, compare the tracked parameter to the trigger value to determine if the area fill region is being printed after a threshold number of swaths, and apply a change to a variable interswath delay of movement of a printer carriage corresponding to a printing operation for printing the area fill region beyond the threshold number of swaths when the parameters achieve the trigger value (e.g., change a variable interswath delay of the carriage when the area fill is to be printed after a threshold number of swath corresponding to the sensitivity level of the delay-sensitive color combination). For another example, the processor resource 222 may carry out a set of instructions to identify a number of consecutive swaths of the region that use the same color across the scan axis, identify a threshold number of swaths to be printed maintained in same color proportions of the region based on color values of the color for the area fill region, determine a number of subsequent swaths beyond the threshold number of swaths, evaluate the image data of the number of subsequent swaths against a previous swath, and delay movement of the carriage in between swaths according to the evaluation of the number of subsequent swaths to the previous swath. For yet another example, the processor resource 222 may carry out a set of instructions to determine that the color of the area fill region is a color sensitive color combination via a densitometer analysis to identify and associate a delay with the sensitive color combination based on a composition of the color compared to predetermined colors with color variation sensitivity when the area fill is to be printed after a threshold number of swaths corresponding to a sensitivity level of the delay-sensitive combination. For yet another example, the processor resource 222 may carry out a set of instructions to retrieve and use a lookup table entry corresponding to the color to identify a color variation trigger value or dynamically compute the trigger value of the color based on a composition of the color compared to predetermined colors with color variation sensitivity and a predetermined delay corresponding to the color variation sensitivity of the colors of the composition. For yet another example, the processor resource 222 may carry out a set of instructions to determine a job width and a job length from image data, the image data being raster image processed data and apply the change of the variable interswath delay of movement of the carriage based on a location of the area fill region with respect to a scan axis of the printer direction and a direction of a swath to be printed.

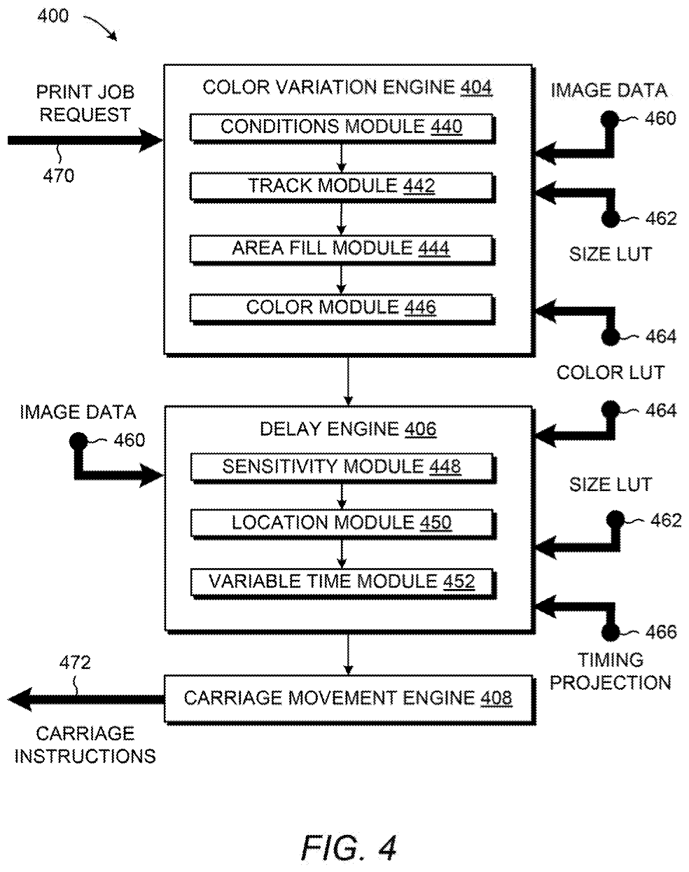

Although these particular modules and various other modules are illustrated and discussed in relation to FIG. 2 and other example implementations, other combinations or sub-combinations of modules may be included within other implementations. Said differently, although the modules illustrated in FIG. 2 and discussed in other example implementations perform specific functionalities in the examples discussed herein, these and other functionalities may be accomplished, implemented, or realized at different modules or at combinations of modules. For example, two or more modules illustrated and/or discussed as separate may be combined into a module that performs the functionalities discussed in relation to the two modules. As another example, functionalities performed at one module as discussed in relation to these examples may be performed at a different module or different modules. FIG. 4 depicts yet another example of how functionality may be organized into modules.

A processor resource is any appropriate circuitry capable of processing (e.g., computing) instructions, such as one or multiple processing elements capable of retrieving instructions from a memory resource and executing those instructions. For example, the processor resource 222 may be a central processing unit (CPU) that enables interswath delay adjustments by fetching, decoding, and executing modules 204 and 206. Example processor resources include at least one CPU, a semiconductor-based microprocessor, a programmable logic device (PLD), and the like. Example PLDs include an application specific integrated circuit (ASIC), a field-programmable gate array (FPGA), a programmable array logic (PAL), a complex programmable logic device (CPLD), and an erasable programmable logic device (EPLD). A processor resource may include multiple processing elements that are integrated in a single device or distributed across devices. A processor resource may process the instructions serially, concurrently, or in partial concurrence.

A memory resource represents a medium to store data utilized and/or produced by the system 200. The medium is any non-transitory medium or combination of non-transitory media able to electronically store data, such as modules of the system 200 and/or data used by the system 200. For example, the medium may be a storage medium, which is distinct from a transitory transmission medium, such as a signal. The medium may be machine-readable, such as computer-readable. The medium may be an electronic, magnetic, optical, or other physical storage device that is capable of containing (i.e., storing) executable instructions. A memory resource may be said to store program instructions that when executed by a processor resource cause the processor resource to implement functionality of the system 200 of FIG. 2. A memory resource may be integrated in the same device as a processor resource or it may be separate but accessible to that device and the processor resource. A memory resource may be distributed across devices.

In the discussion herein, the engines 104 and 106 of FIG. 1 and the modules 204 and 206 of FIG. 2 have been described as circuitry or a combination of circuitry and executable instructions. Such components may be implemented in a number of fashions. Looking at FIG. 2, the executable instructions may be processor-executable instructions, such as program instructions, stored on the memory resource 220, which is a tangible, non-transitory computer-readable storage medium, and the circuitry may be electronic circuitry, such as processor resource 222, for executing those instructions. The instructions residing on a memory resource may comprise any set of instructions to be executed directly (such as machine code) or indirectly (such as a script) by a processor resource.

In some examples, the system 200 may include the executable instructions may be part of an installation package that when installed may be executed by a processor resource to perform operations of the system 200, such as methods described with regards to FIGS. 3-7. In that example, a memory resource may be a portable medium such as a compact disc, a digital video disc, a flash drive, or memory maintained by a computer device, such as a web server, from which the installation package may be downloaded and installed. In another example, the executable instructions may be part of an application or applications already installed. A memory resource may be a non-volatile memory resource such as read only memory (ROM), a volatile memory resource such as random access memory (RAM), a storage device, or a combination thereof. Example forms of a memory resource include static RAM (SRAM), dynamic RAM (DRAM), electrically erasable programmable ROM (EEPROM), flash memory, or the like. A memory resource may include integrated memory such as a hard drive (HD), a solid state drive (SSD), or an optical drive.

FIG. 3 depicts an example print apparatus 390 in which various imaging systems 300 may be implemented. The example print apparatus 390 is shown to include an example print system 300 for enabling variable interswath delay based on area fill characteristics. The system 300 (described herein with respect to FIGS. 1 and 2) may represent generally any circuitry or combination of circuitry and executable instructions to identify an interswath delay corresponding to the color and size of the area fill region. The system 300 may include a controller 312 to actuate movement of a carriage 314 on a track 316 along a scan axis represented by line 315 and actuate a print head coupled to the carriage 314 to eject print fluid on to a print medium 310. A controller, as used herein, represents a combination of circuitry and executable instructions, such as a processor resource coupled to a memory resource with a control program stored thereon that, when executed by the processor resource, cause the processor resource to perform an operation of the control program.

The print apparatus 390 of FIG. 3 is in a state of printing a job based on image data to produce area fill 330 and area fill 340 on the medium 310. The image data may be analyzed in regions, such as regions corresponding to swaths of the area fill 330 and swaths of the area fill 340. Each region may have a different interswath delay. An interswath delay used to print region 340 may be less than the interswath delay used to print the region 330. For example, the region 340 may be an area fill of a different color that is less sensitive than the color of the region 330 and therefore a different interswath delay may be used with the number of swaths used to print region 340 in comparison to interswath delay used with the number of swaths to print region 330. For another example, an interswath delay may be a minimal variable interswath delay (e.g., zero) for the swaths used to print region 340 because the width 341 of the area fill region 340 may not achieve a scan axis width threshold to effect the color variation properties of a print head of the print apparatus 390, whereas the width 331 of the region 330 may achieve or exceed the scan axis width threshold. For yet another example, the number of swaths along the length 343 used to print region 340 may not exceed the variation threshold number of swaths to effect the color variation properties of a print head of the print apparatus 390, whereas the number of swaths along the length 333 used to print region 330 may exceed the variation threshold. In this manner, each swath may be analyzed according to corresponding image data to determine whether a delay is to be applied to correct color variation based on the output of the print job as induced based on the properties and characteristics of the print apparatus 390. Such properties and characteristics may include ink flux properties, firing characteristics, and print head characteristics. Example properties and characteristics include ink flux per nozzle such as average ink flux per nozzle over a range of nozzles, firing energy, firing voltage, firing pulse, firing methods, print head temperatures such as die surface temperature, trickle warm temperature, and the like.

FIG. 4 depicts example components used to implement example imaging systems 400. Referring to FIG. 4, the example components of FIG. 4 generally include a color variation engine 404, a delay engine 406, and a carriage movement engine 408. The example components of FIG. 4 may be implemented on a compute device, such as printing apparatus 390 of FIG. 3 (e.g., programmed instructions as part of the controller 312 of FIG. 3).

The color variation engine 404 includes program instructions (such as a conditions module 440, a track module 442, an area fill module 444, and a color module 446) to assist identification of a delay-sensitive area fill region of a print job request 470. The modules 440, 442, 444, and 446 may use the image data 460, the size lookup table 462, and/or the color lookup table 464 in performing operations when executed by a processor resource.

The conditions module 440 represents program instruction that when executed cause a processor resource to determine parameters, including a job width and length from raster image processed data (e.g., the image data 460 of FIG. 4). Other parameters may include a job type (e.g., a graphics print job or a technical print job), a tiling mode, and a print mode. The track module 442 represents program instructions that when executed cause a processor resource to track parameters of the print job including primary color values and an amount of each print fluid to be printed during each swath of the print job. The area fill module 444 represents program instructions that when executed cause a processor resource to determine a region of area fill. For example, if a consistent amount of a color combination is still being printed after a predetermined given number of swaths that can be a risk for color consistency. Execution of the area fill module 444 may utilize the size lookup table 462 to assist identification of regions having properties that indicate the area is an area fill. The color module 446 represents program instructions that when executed cause a processor resource to determine the color of the area fill region identified by executing the area fill module 444. For example, the color may be determined based on the primary color values to be used to reproduce the image data at the region identified by executing the area fill module 444. Execution of the color module 446 may utilize the color lookup table 464 to assist identification of color combinations that may provide a potential color variation condition.

The delay engine 406 includes program instructions (such as a sensitivity module 448, location module 450, and variable time module 452) to assist identification of a delay to apply to movement of a printer carriage. The modules 448, 450, and 452 may use the image data 460, the size lookup table 462, and/or the color lookup table 484 in performing operations when executed by a processor resource.

The sensitivity module 448 represents program instructions that when executed cause a processor resource to the sensitivity of the area fill region identified by executing the area fill module 444 based on the color combination to be printed in the region identified by executing the color module 446. If multiple sections of color are to be printed in the region, the sensitivity to inform the delay engine may be based on the combination of colors or a sub-region (such as the region of the most sensitive color combination of the color combinations to be printed). The location module 450 represents program instructions that when executed cause a processor resource to identify a location of the region with respect to the media size and/or the position of along the scan axis of the printer and determine if any adjustments are to be made, increased, or decreased based on the location. The variable time module 452 represents program instructions that when executed cause a processor resource to identify the delay, including travel time to the location, and identify an adjustment in variable interswath delay to achieve the delay with respect to the average interswath delay, where, in that example, the variable interswath delay is customizable and the average interswath delay is a standard delay during average operation. Execution of the variable time module 452 may utilize a timing projection 468 corresponding to the amount of time corresponding to travel of the carriage for a swath or a region of swaths, where the projected timings may be adjusted based on the determinations of the delay engine 406 and carriage movement instructions 472 generated accordingly.

The carriage engine 408 represents circuitry or a combination of circuitry and executable instructions to generate instructions to apply a delay to movement of a carriage (such as instructions to adjust an interswath delay of a printer carriage among a number of passes) as determined by the delay engine 406. The carriage instructions 472 generated by the carriage movement engine 408 are applied to the motors in charge of actuation of the movement of the carriage or otherwise sent to the controller or other mechanism for operating the carriage with the identified delay.

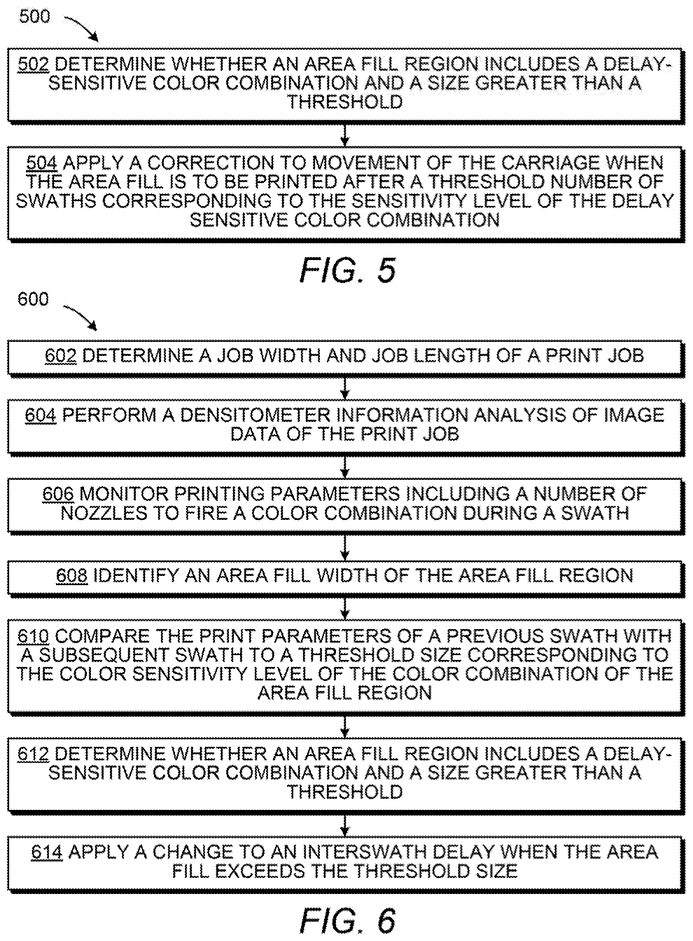

FIGS. 5-7 are flow diagrams depicting example methods 500, 600, and 700 of operating a carriage of a printer. Referring to FIG. 5, example methods 500 of operating a carriage of a printer may generally comprise identifying a delay-sensitive area fill and applying a change to carriage movement according to the sensitivity of the identified delay-sensitive area fill. The methods 500, 600, and 700 are performable by systems discussed herein, such as systems 100, 200, 300 and 400.

At block 502, a delay-sensitive color combination is determined to be part of an area fill region and the size of the area fill is determined to be greater than a threshold. The operations at block 502 may include determining a region is an area fill, determining the area fill region of a print job is to include a delay-sensitive color combination, and determining that the area fill region has a width along a scan axis of the carriage that is greater than a threshold width corresponding to a sensitivity level of the delay-sensitive color combination. The operations at block 502 may identify a threshold size to achieve a color variation of a color combination and/or may identify a color combination sensitive at the size of the area fill region using predetermined resources, such as a lookup table, or by dynamically computing the threshold size and sensitivity and comparing the computations to a region of image data.

At block 504, a correction to movement of the carriage of the printer is applied after a threshold number of swaths corresponding to the sensitivity level of the delay-sensitive color combination identified at block 502. The operations at block 504 may include applying a change to movement of a printer carriage during a printing operation for printing the area fill region that extends beyond the predetermined number of swaths when the parameters achieve the trigger value (e.g., when the primary color values corresponding to pixels of the region achieve or exceed a size threshold and the color combination threshold).

FIG. 6 includes blocks similar to blocks of FIG. 5 and provides additional blocks and details. In particular, FIG. 6 depicts additional blocks and details generally regarding determining, monitoring, and comparing printing parameters. Blocks 612 and 614 are similar to blocks 502 and 504 of FIG. 5 and, for brevity, their respective descriptions are not repeated.

At block 602, printing parameters of a print job, including a job width and a job length, are determined from raster image processed data. At block 604, a region of image data is determined to be an area fill from an internal densitometer information analysis operation performed on image data of the print job and is beyond the media width and/or the job length is beyond the media length. This generally indicates a tiling job is to be printed and the printer may print in a tiling mode (e.g., print images to be printed separately and then aligned together to make a final output image). With tiling jobs, it is desirable that the colors of each tile match, in particular when the same color of each tile are aligned adjacent to each other. For example, if there is a color variation on a first tile compared to a second tile, the variation may be readily detectable at the seam where the tiles are applied together. The internal densitometer information analysis may use primary color values corresponding to identify when a region includes an area fill.

At block 606 printing parameters are monitored. The printing parameters monitor may include a number of nozzles to fire a color combination, such as the color combination of the area fill region. At block 608, the area fill width of the area fill region is identified. The area fill width is compared to a threshold size corresponding to the color sensitivity level of the color combination of the area fill region. The width of the area fill may indicate whether a threshold level of area fill corresponding to a sensitivity level may be achieved. With the width of the area fill identified, the length of the area fill is to be identified to determine the size of the area fill. At block 610, the length of the area fill may be identified based on the printing parameters monitored at block 606. For example, the nozzles of a print head to be fired for a previous swath are compared with the nozzles of the print head to be fired a subsequent swath. In this manner, the print parameters of the swaths are compared to a threshold size corresponding to the color sensitivity level of the color combination of the area fill region. The thresholds may vary based on the color combination of the area fill, such that, at block 612, it is determined whether a region includes a delay-sensitive color combination and is a size greater than the threshold corresponding to color variation potential of the delay-sensitive color combination. At block 614, a change to a variable interswath delay is applied when the area fill exceeds the threshold size and the threshold number of swaths corresponding to the delay-sensitive color combination. In this manner, the delay is applied when the area fill region is large enough in both length and width corresponding to an amount of ink that may produce a color variation over time of the print job.

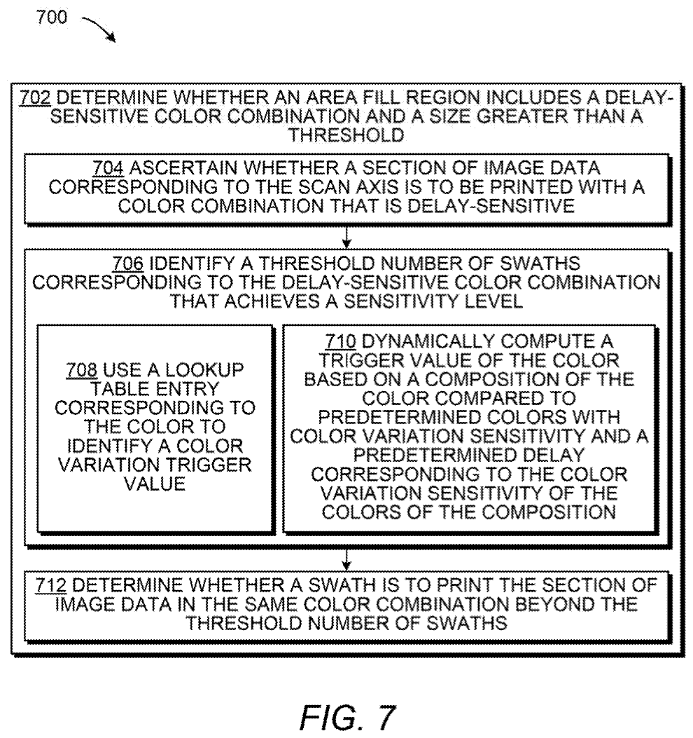

Referring to FIG. 7, method 700 is an example of operations performed to determine whether an area fill region includes a delay-sensitive color combination and is of a size greater than a corresponding threshold. In this manner, block 702 represents operations performable by blocks 502 of method 500 and/or 612 of method 600.

At block 704, a section of image data corresponding to a scan axis is ascertained to be printed with a color combination. For example, a pass of a carriage of a print head may correspond to a set of image data, where a consecutive number of firings corresponding to the scan axis are to be printed in the same color combination. The operations at block 704 may also include ascertaining whether the color combination is sensitive to carriage delay or not.

At block 706, a threshold number of swaths is identified corresponding the color combination that achieves a sensitivity level of the color combination. The thresholds may vary based on the color combination of the area fill and may vary based on the sensitivity level being analyzed. The operations of block 706 may use a lookup table entry corresponding to the color to identify a color variation threshold (e.g., trigger value) at block 708 and/or dynamically compute the color variation threshold at block 710. The operations at block 710 to dynamically compute the color variation threshold may be based on a composition of the color compared to predetermined colors with color variation sensitivity and a predetermined delay corresponding to the color variation sensitivity of the colors of the composition.

At block 712, a swath is determined to print the section of image data in the same color combination beyond the threshold number of swaths, thus indicating a color variation potential and a corrective interswath delay should be applied (e.g., see blocks 504 and 614 of methods 500 and 600 respectively). By actively tracking the potential for color variation of area fill regions, movement of the carriage may be corrected according to encourage consistent colors across the entire print job, in particular across multiple tiles of the same job.

Although the flow diagrams of FIGS. 4-7 illustrate specific orders of execution, the order of execution may differ from that which is illustrated. For example, the order of execution of the blocks may be scrambled relative to the order shown. Also, the blocks shown in succession may be executed concurrently or with partial concurrence. All such variations are within the scope of the present description.

All of the features disclosed in this specification (including any accompanying claims, abstract and drawings), and/or all of the elements of any method or process so disclosed, may be combined in any combination, except combinations where at least some of such features and/or elements are mutually exclusive.

The terms “include,” have, and variations thereof, as used herein, mean the same as the term “comprise” or appropriate variation thereof. Furthermore, the term “based on,” as used herein, means “based at least in part on.” Thus, a feature that is described as based on some stimulus may be based only on the stimulus or a combination of stimuli including the stimulus. Furthermore, the use of the words “first,” “second,” or related terms in the claims are not used to limit the claim elements to an order or location, but are merely used to distinguish separate claim elements.

The present description has been shown and described with reference to the foregoing examples. It is understood, however, that other forms, details, and examples may be made without departing from the spirit and scope of the following claims.

What is claimed is:

1. A system comprising:
a carriage comprising a print head receiving station;
a color variation engine to identify a potential color variation condition corresponding to an area fill region of image data of a print job based on a color combination of the area fill region and a size of the area fill region; and
a delay engine to apply a carriage delay strategy according to the identified potential color variation condition and the size of the area fill region.

2. The system of claim 1, wherein the color variation engine is to:
determine which swaths correspond to an area fill region of image; and
compare a number of swaths of the print job for the region to a variation threshold corresponding to the color combination.

3. The system of claim 2, wherein:
the color variation engine is to retrieve a color prone difference from a lookup table that includes an array of sensitive colors and interswath delays corresponding to each of the sensitive colors; or
the delay engine is to calculate an interswath delay based on the number of swaths of the print job for the area fill region and the number of swaths exceeding a variation threshold corresponding to the color combination.

4. The system of claim 1, wherein:
the color variation engine tracks the output of the swaths printing a color combination for more than a threshold number of swaths;
the carriage delay strategy identifies an amount of time to delay between swaths in addition to interswath delay under average operation; and
the amount of time is a variable amount of time less than one second and greater than zero.

5. The system of claim 1, wherein the delay engine is to:
determine an interswath delay based on a size of a number of tiles of the print job and a job length of the print job; and
determine an adjustment of the interswath delay based on the location of the area fill region compared to the size of the number of tiles.

6. A non-transitory computer-readable storage medium comprising a set of instructions executable by a processor resource to:
determine a trigger value corresponding to conditions that identify image data includes an area fill region of a threshold width and a color for the area fill region is prone to show color variation beyond a threshold amount;
track a parameter of the image data corresponding to the area fill region;
compare the tracked parameter to the trigger value to determine if the area fill region is being printed after a threshold number of swaths; and
apply a change to a variable interswath delay of movement of a printer carriage corresponding to a printing operation for printing the area fill region beyond the threshold number of swaths when the parameters achieve the trigger value.

7. The medium of claim 6, wherein the set of instructions to identify that image data includes an area fill region is executable by the processor resource to:
identify a number of consecutive swaths of the region that use the same color across the scan axis;
identify a threshold number of swaths to be printed maintained in same color proportions of the region based on color values of the color for the area fill region;
determine a number of subsequent swaths beyond the threshold number of swaths; and
evaluate the image data of the number of subsequent swaths against a previous swath.

8. The medium of claim 6, wherein the set of instructions to identify that image data includes an area fill region is executable by the processor resource to:
determine that the color of the area fill region is a color sensitive color combination; and
associate a delay with the sensitive color combination based on a composition of the color compared to predetermined colors with color variation sensitivity.

9. The medium of claim 6, wherein the set of instructions to identify that image data includes an area fill region is executable by the processor resource to:
use a lookup table entry corresponding to the color to identify a color variation trigger value; or
dynamically compute the trigger value of the color based on a composition of the color compared to predetermined colors with color variation sensitivity and a predetermined delay corresponding to the color variation sensitivity of the colors of the composition.

10. The medium of claim 6, wherein the set of instructions is executable by the processor resource to:
determine a job width and a job length from image data, the image data being raster image processed data; and
apply the change of the variable interswath delay of movement of the carriage based on a location of the area fill region with respect to a scan axis of the printer direction and a direction of a swath to be printed.

11. A method of operating a carriage of a printer comprising:
determining an area fill region of a print job is to include a delay-sensitive color combination and that the area fill region has a width along a scan axis of the carriage that is greater than a threshold width corresponding to a sensitivity level of the delay-sensitive color combination; and
applying a correction to movement of the carriage when the area fill is to be printed after a threshold number of swaths corresponding to the sensitivity level of the delay-sensitive color combination.

12. The method of claim 11, comprising:
determining a job width and job length from raster image processed data; and
determining, from an internal densitometer information analysis, an area fill is to be printed when the job width exceeds the media width and when the job length exceeds the media length.

13. The method of claim 12, comprising:
ascertaining that a section of image data corresponding to the scan axis is to be printed with the color combination;
identifying the threshold number of swaths corresponding to the delay-sensitive color combination that achieves the sensitivity level; and
determining whether a swath is to print the section of image data in the same color combination beyond the threshold number of swaths.

14. The method of claim 13, comprising:
monitoring printing parameters including a number of nozzles to fire a color combination during a swath; and
comparing the print parameters of a previous swath with a subsequent swath.

15. The method of claim 14, comprising:
identifying an area fill width of the area fill region; and
comparing the area fill width to a threshold size corresponding to the color sensitivity level of the color combination of the area fill region;
wherein applying the correction comprises applying a change to a variable interswath delay when the area fill exceeds the threshold size and the threshold number of swaths.
